(19) United States
(12) Patent Application Publication
(10) Pub. No.: US 2016/0117554 A1
(43) Pub. Date: Apr. 28, 2016

(54) APPARATUS AND METHOD FOR EYE TRACKING UNDER HIGH AND LOW ILLUMINATION CONDITIONS

(71) Applicant: SAMSUNG ELECTRONICS CO., LTD., Suwon-si (KR)

(72) Inventors: Byong Min KANG, Yongin-si (KR); Dongwoo KANG, Seoul (KR); Jingu HEO, Yongin-si (KR)

(21) Appl. No.: 14/708,573

(22) Filed: May 11, 2015

(30) Foreign Application Priority Data
Oct. 22, 2014 (KR) 10-2014-0143279

(51) Int. Cl. G06K 9/00; H04N 5/225; H04N 5/232; H04N 5/33

(52) U.S. Cl. CPC G06K 9/00604; H04N 5/33; H04N 5/2256; H04N 5/23245

(57) ABSTRACT

An eye tracking apparatus is operable in both first and second illumination environments where the second illumination is associated with a higher illumination environment than the first illumination. The apparatus includes an image capturer configured to capture an image of a user, an image processor configured to detect an eyepoint of the user in the captured image, and an optical source configured to emit infrared light to the user in a first illumination mode. The image capturer includes a dual bandpass filter configured to allow infrared light and visible light to pass.

### CROSS-REFERENCE TO RELATED APPLICATION

This application claims the priority benefit of Korean Patent Application No. 10-2014-0143279, filed on Oct. 22, 2014, in the Korean Intellectual Property Office, the entire contents of which are incorporated herein by reference in its entirety.

### BACKGROUND

1. Field

At least some example embodiments relate to an image capturing and displaying apparatus.

2. Description of the Related Art

An apparatus for capturing an image under a high illumination condition and an apparatus for capturing an image under a low illumination condition are used to capture the image under the high and the low illumination conditions. For example, an image capturing apparatus using visible light may be used under the high illumination condition and an image capturing apparatus using infrared light may be used under the low illumination condition.

Recently, three-dimensional (3D) display devices have been developed. In line with the development, a 3D display method such as a glassless display method has been developed in place of a conventional method using glasses. For such a glassless display method, tracking an eyepoint of a user may be used.

In such a technological environment, a 3D display that may flexibly track the eyepoint both in a bright and a dark environment may be used. For example, a doctor may examine a patient in the dark environment and explain a result of the examining to the patient in the bright environment. In such an example, a camera for tracking an eyepoint may operate normally in the bright environment, but operate abnormally in the dark environment. Here, an infrared camera may be additionally used. However, a size and a cost may increase due to the addition of the infrared camera.

Accordingly, there is a desire for an image capturing apparatus that is operable both in a high and a low illumination condition.

### SUMMARY

At least some example embodiments relate to an eye tracking apparatus.

In at least some example embodiments, the eye tracking apparatus may include an image capturer configured to capture an image of a user, an image processor configured to detect an eyepoint of the user in the captured image, and a controller configured to determine an operating mode based on an ambient illumination and control an operation of at least one of the image capturer and the image processor based on the determined operating mode, the determined operating mode being one of a first illumination mode and a second illumination mode where the second illumination mode is associated with a higher illumination environment than the first illumination mode.

The controller may determine the operating mode by comparing the ambient illumination to a threshold value.

The eye tracking apparatus may further include an optical source configured to emit infrared light to the user in the first illumination mode.

The optical source may emit near-infrared light within a center of 850 nanometers (nm) and a bandwidth of 100 nm in the first illumination mode.

The image capturer may include a dual bandpass filter configured to allow visible light and infrared light to pass.

The dual bandpass filter may allow visible light within a wavelength of 350 nm to 650 nm and near-infrared light within a wavelength of 800 nm to 900 nm to pass.

The image processor may detect the eyepoint of the user in the captured image using a feature point from a first database including visible images in the second illumination mode, and detect the eyepoint of the user in the captured image using a feature point from a second database including infrared images in the first illumination mode.

The image capturer may further include an image corrector configured to correct the captured image. The image corrector may perform demosaicing on the captured image in the second illumination mode.

At least other example embodiments relate to an image capturing apparatus.

In at least some example embodiments, the image capturing apparatus may include a controller configured to determine an operating mode based on an ambient illumination, the determined operating mode being one of a first illumination mode and a second illumination mode, the second illumination mode associated with a higher illumination environment than the first illumination mode, an optical source configured to emit infrared light to a target area in the first illumination mode, a dual bandpass filter configured to allow infrared light and visible light to pass, an image sensor configured to generate an image by receiving light filtered by the dual bandpass filter, and an image corrector configured to correct the generated image.

The optical source may emit near-infrared light within a center of 850 nm and a bandwidth of 100 nm. The dual bandpass filter may allow visible light within a wavelength of 350 nm to 650 nm and infrared light within a wavelength of 800 nm to 900 nm to pass.

The image corrector may perform demosaicing on the generated image in the second illumination mode.

At least other example embodiments relate to an eye tracking method.

In at least some example embodiments, the eye tracking method may include determining an operating mode based on an ambient illumination, the determined operating mode being one of a first illumination mode and a second illumination mode, the second illumination mode associated with a higher illumination environment than the first illumination mode, capturing an image of a user based on the determined operating mode, and detecting an eyepoint of the user in the captured image.

The eye tracking method may further include emitting infrared light to the user in the first illumination mode.

The capturing may be based on reflected light passing through a dual bandpass filter configured to allow visible light and infrared light to pass.

The capturing may include capturing a visible image of the user in the second illumination mode, and capturing an infrared image of the user in the first illumination mode.

The detecting may use a feature point from a first database including visible images in the second illumination mode.

The detecting may use a feature point from a second database including infrared images in the first illumination mode.

The eye tracking method may further include demosaicing the captured image in the second illumination mode.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a diagram illustrating an example of an eye tracking apparatus according to at least one example embodiment;

FIG. 2 illustrates an example of spectral distribution characteristics of red, green, and blue (RGB) pixels according to at least one example embodiment;

FIG. 3 illustrates an example of a dual bandpass filter according to at least one example embodiment;

FIG. 4 illustrates an example of characteristics of a visible image and an infrared image according to at least one example embodiment;

FIG. 5 illustrates an example of demosaicing to be performed on a visible image according to at least one example embodiment;

FIGS. 6A through 6C illustrate an example of detecting an eyepoint of a user according to at least one example embodiment;

FIG. 7 is a diagram illustrating an example of an image capturing apparatus according to at least one example embodiment;

FIG. 8 is a diagram illustrating an example of a three-dimensional (3D) image display device according to at least one example embodiment; and

FIG. 9 is a flowchart illustrating an example of an eye tracking method according to at least one example embodiment.

### DETAILED DESCRIPTION

Hereinafter, at least some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

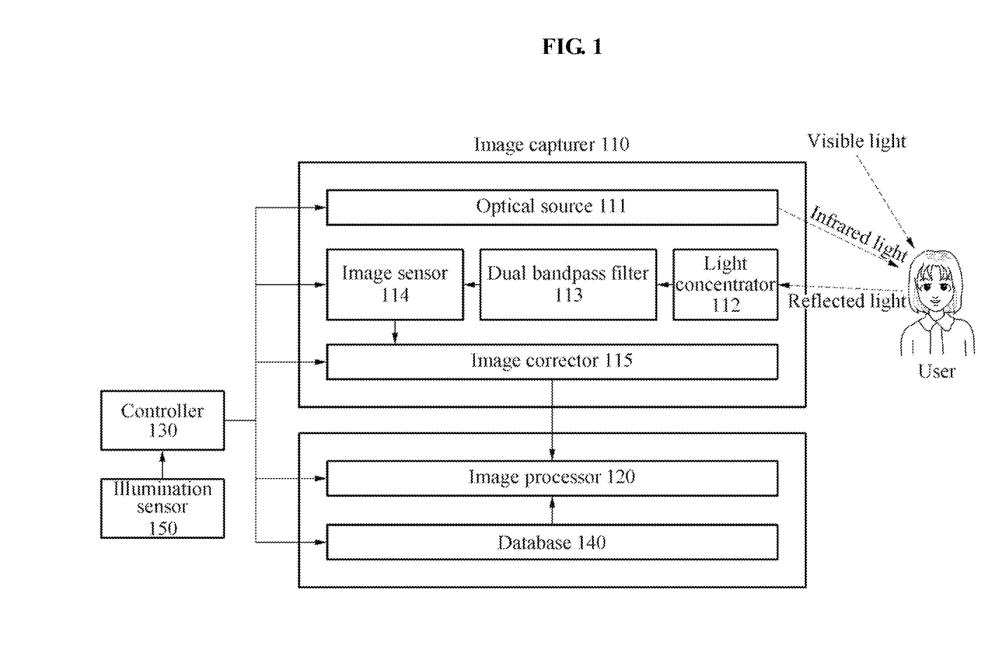

FIG. 1 is a diagram illustrating an example of an eye tracking apparatus according to at least one example embodiment.

Referring to FIG. 1, the eye tracking apparatus includes an image capturer 110, an image processor 120, and a controller 130. In addition, the eye tracking apparatus includes a database 140 and an illumination sensor 150.

The image capturer 110 captures an image of a user through visible light and infrared light in a high illumination environment and a low illumination environment. The image capturer 110 includes an optical source 111, a light concentrator 112, a dual bandpass filter 113, an image sensor 114, and an image corrector 115.

The high illumination environment may refer to an environment in which an image from which an eyepoint of the user is identifiable may be captured without using an additional infrared optical source. For example, the high illumination environment may be an indoor environment in which a sufficient amount of light is emitted. The low illumination environment may refer to an environment using the additional infrared optical source to capture an image from which the eyepoint of the user is identifiable. For example, the low illumination environment may be an indoor environment in which an insufficient amount of light is emitted.

The optical source 111 emits infrared light to the user. The optical source 111 may emit the infrared light to the user under a control of the controller 130. The optical source 111 may emit near-infrared light within a center of 850 nanometers (nm) and a bandwidth of 100 nm.

The light concentrator 112 concentrates reflected light from visible light or infrared light. The light concentrator 112 may include a lens or a pinhole to concentrate the reflected light.

The dual bandpass filter 113 allows visible light and infrared light of the reflected light concentrated by the light concentrator 112 to pass. The dual bandpass filter 113 may allow visible light within a wavelength of 350 nm to 650 nm and near-infrared light within a wavelength of 800 nm to 900 nm to pass. The dual bandpass filter 113 may be an optical filter.

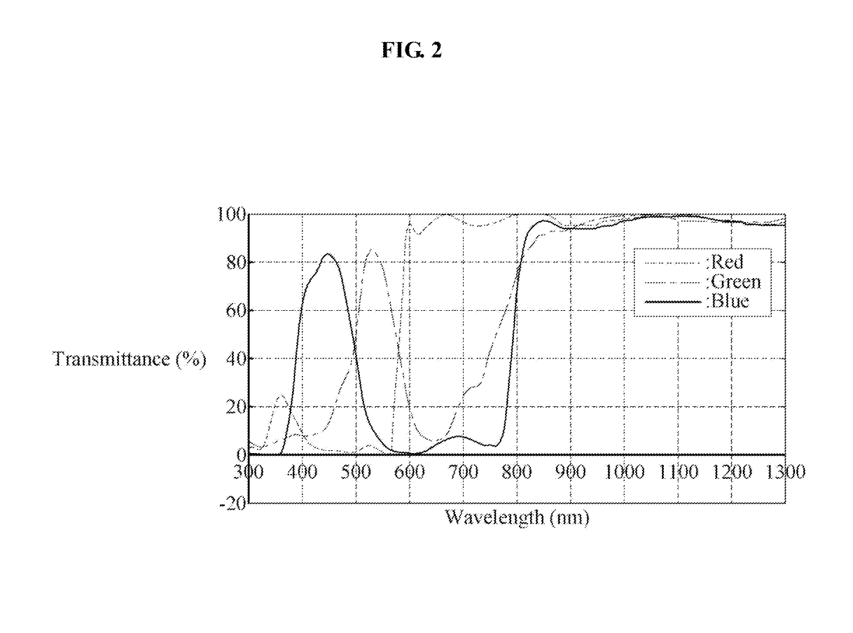

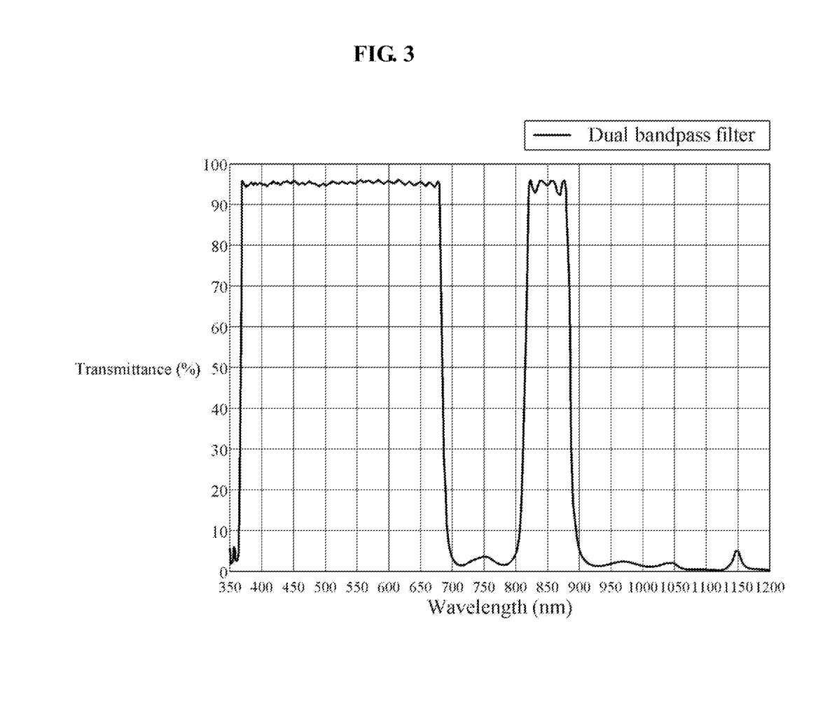

The dual bandpass filter 113 will be further described with reference to FIGS. 2 and 3.

FIG. 2 illustrates an example of spectral distribution characteristics of red, green, and blue (RGB) pixels according to at least one example embodiment.

FIG. 2 illustrates transmittances of red, green and blue (RGB) pixels based on a wavelength. In general, a camera may exclusively receive, through an image sensor, visible light that may be perceived by a human being using an infrared cut-off filter. In general, the infrared cut-off filter may allow light within a band of 350 nm to 650 nm to pass. The image capturer 110 of FIG. 1 does not apply the infrared cut-off filter to use infrared light. When the infrared cut-off filter is not used, an overall captured image may be reddened.

Such a reddening issue may be due to a characteristic of a Bayer pattern color filter used for an image sensor. In the Bayer pattern color filter, each pixel may have any one filter of red, green, and blue. When the infrared cut-off filter is removed from the camera and light within a band of 350 nm to 800 nm enters, a transmittance of a red pixel may become higher than a transmittance of a green pixel and a blue pixel and thus, the image may, overall, become reddened.

However, although the image capturer 110 does not use the infrared cut-off filter, the image may not be reddened because the dual bandpass filter 113 of FIG. 1 blocks a certain wavelength from an infrared region.

FIG. 3 illustrates an example of the dual bandpass filter 113 of FIG. 1 according to at least one example embodiment.

Referring to FIG. 3, the dual bandpass filter 113 may block light within a band of 650 nm to 800 nm, and allow visible light within a band of 350 nm to 650 nm and near-infrared light within a band of 800 nm to 900 nm to pass.

The optical source 111 of FIG. 1 may emit infrared light within a center of 850 nm and a bandwidth of 100 nm. Thus, the image sensor 114 of FIG. 1 may exclusively receive reflected light from the infrared light emitted by the optical source 111 because visible light does not exist in a low illumination environment. In addition, the image sensor 114 may exclusively receive reflected light from the visible light because the optical source 111 may not emit infrared light in a high illumination environment. Thus, the image capturer 110 of FIG. 1 may capture an image of a user both in both the high and the low illumination environments using the optical source 111 and the dual bandpass filter 113.

The dual bandpass filter 113 may be hardware, firmware, hardware executing software or any combination thereof. When the dual bandpass filter 113 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the dual bandpass filter 113. As stated above, CPUs, DSPs, ASICs and FPGAs may generally be referred to as processing devices.

In the event where the dual bandpass filter 113 is a processor executing software, a processor is configured as a special purpose machine to execute the software, stored in a storage medium, to perform the functions of the dual bandpass filter 113.

Referring back to FIG. 1, the image sensor 114 may receive light passing through the dual bandpass filter 113. The image sensor 114 may generate an image based on the received light. The image sensor 114 may include a charge-coupled device (CCD) or a complementary metal oxide semiconductor (CMOS).

The image corrector 115 of FIG. 1 may correct the image generated by the image sensor 114. The image corrector 115 may process a visible image captured in the high illumination environment and an infrared image captured in the low illumination environment using different processes. For example, the image corrector 115 may perform preprocessing, for example, demosaicing, on the visible image captured in the high illumination environment.

The image corrector 115 may be hardware, firmware, hardware executing software or any combination thereof. When the image corrector 115 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the image corrector 115. As stated above, CPUs, DSPs, ASICs and FPGAs may generally be referred to as processing devices.

In the event where the image corrector 115 is a processor executing software, a processor is configured as a special purpose machine to execute the software, stored in a storage medium, to perform the functions of the image corrector 115.

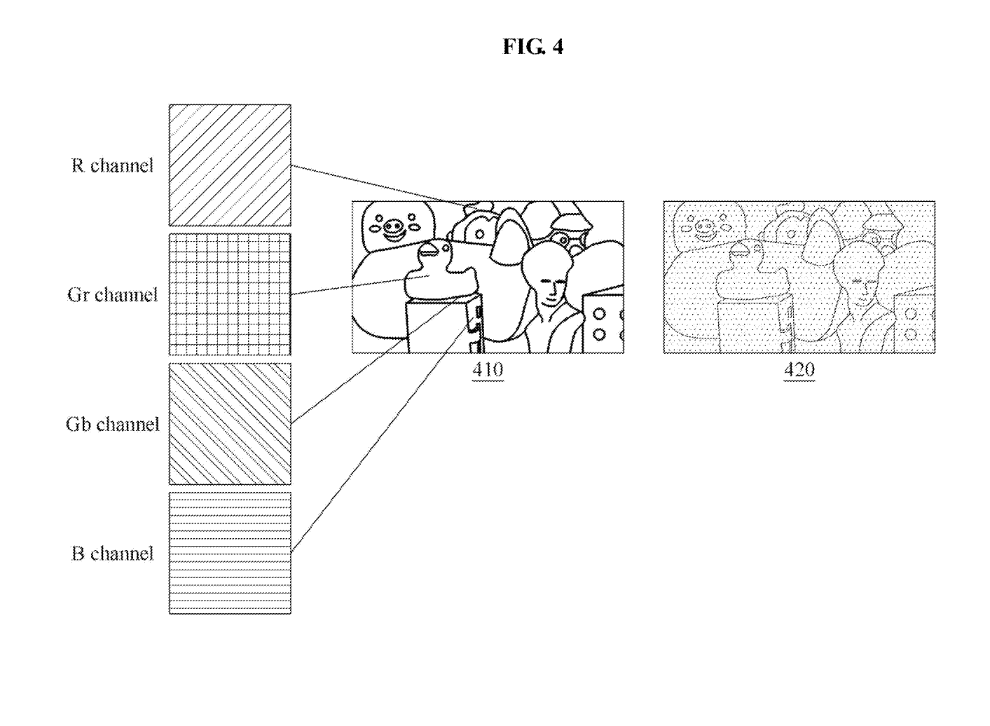

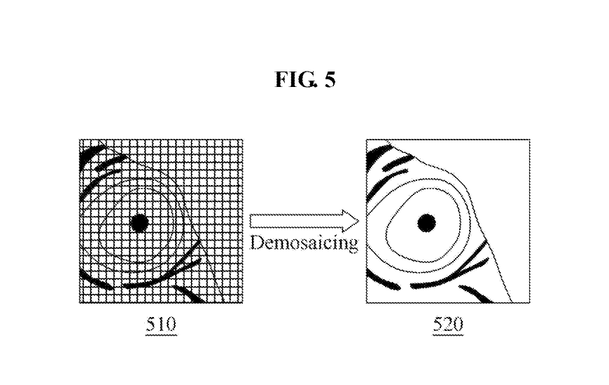

An operation of the image corrector 115 will be further described with reference to FIGS. 4 and 5.

FIG. 4 illustrates an example of characteristics of a visible image 410 and an infrared image 420 according to at least one example embodiment.

FIG. 4 illustrates the visible image 410 and the infrared image 420. The visible image 410 may be captured in a high illumination environment, and the infrared image 420 may be captured in a low illumination environment.

The visible image 410 may include a Bayer pattern including a red (R) channel image, a green/red (Gr) channel image, a green/blue (Gb) channel image, and a blue (B) channel image due to a pixel characteristic of the image sensor 114 of FIG. 1. Thus, the image corrector 115 of FIG. 1 may perform preprocessing, for example, demosaicing to correct the Bayer pattern of the visible image 410.

The infrared image 420 may not include a certain pattern because all pixels are equally weighted. Thus, the image corrector 115 may not perform preprocessing on the infrared image 420.

FIG. 5 illustrates an example of demosaicing to be performed on a visible image according to at least one example embodiment.

FIG. 5 illustrates an image 510 prior to the demosaicing and an image 520 subsequent to the demosaicing. The image 510 prior to the demosaicing may include a grid Bayer pattern. The image corrector 115 of FIG. 1 may perform the demosaicing by predicting a value between pixels in the image 510.

The image 510 may not be suitable for detecting an eyepoint of a user because the image 510 includes the Bayer pattern. Thus, in a high illumination environment, the eyepoint of the user may be detected based on the image 520 obtained subsequent to preprocessing, for example, the demosaicing.

Referring back to FIG. 1, the image processor 120 may detect an eyepoint of a user in an image output from the image corrector 115. The image output from the image corrector 115 may be a visible image on which the demosaicing is performed in the high illumination environment, or an infrared image on which preprocessing is not performed in the low illumination environment. Hereinafter, the image output from the image corrector 115 is referred to as a captured image. The image processor 120 may detect the eyepoint of the user in the captured image.

The image processor 120 may use the database 140 to detect the eyepoint of the user in the captured image. The database 140 may include a first database including visible images, and a second database including infrared images.

The first database may be trained in a feature point of a visible image. The second database may be trained in a feature point of an infrared image. For example, the first database may include various feature points of a facial contour trained from the visible images and data on a position of an eye based on the feature points of the facial contour. The second database may include various feature points of a facial contour trained from the infrared images and data on a position of an eye based on the feature points of the facial contour. In addition, the second database may include data on various feature points of the eye trained from the infrared images.

The image processor 120 may detect the eyepoint of the user in the captured image using a feature point extracted from the first database in the high illumination environment. In addition, the image processor 120 may detect the eyepoint of the user in the captured image using a feature point extracted from the second database in the low illumination environment.

The image processor 120 may be hardware, firmware, hardware executing software or any combination thereof. When the image processor 120 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the image processor 120. As stated above, CPUs, DSPs, ASICs and FPGAs may generally be referred to as processing devices.

In the event where the image processor 120 is a processor executing software, a processor is configured as a special purpose machine to execute the software, stored in a storage medium, to perform the functions of the image processor 120.

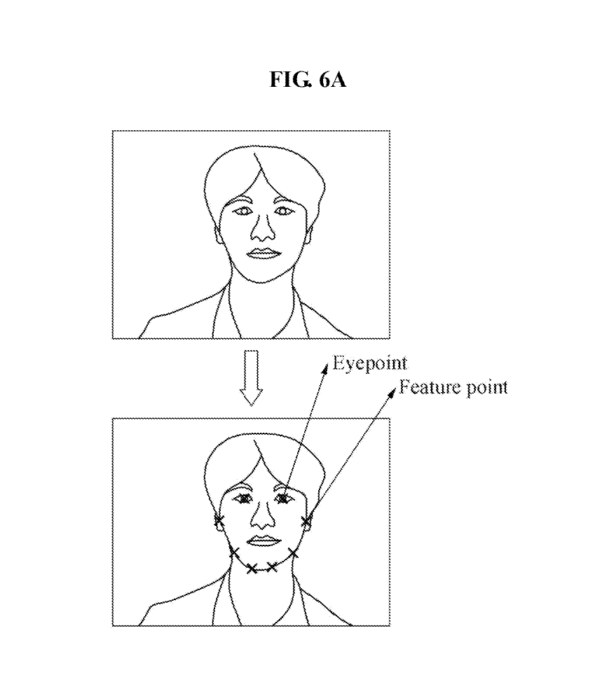

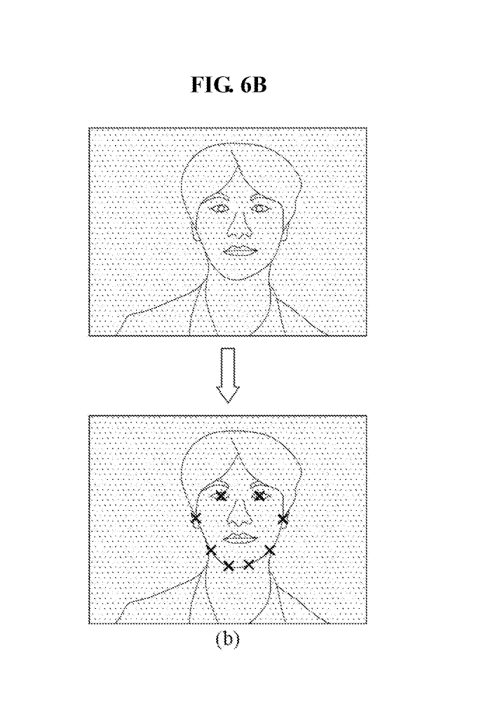

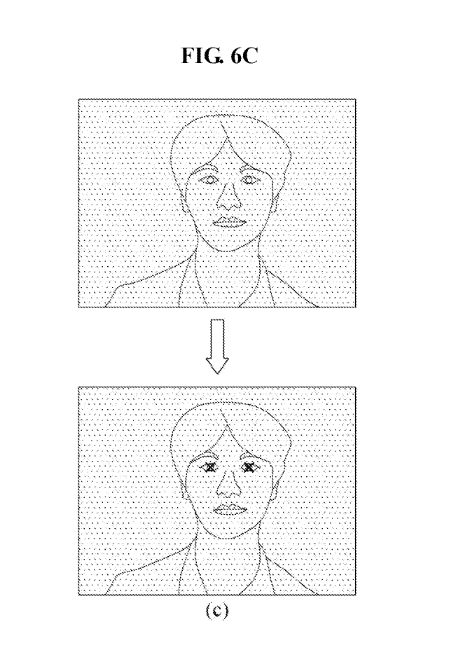

An operation of the image processor 120 will be further described with reference to FIGS. 6A through 6C.

FIGS. 6A through 6C illustrate an example of detecting an eyepoint of a user according to at least one example embodiment.

FIG. 6A illustrates a visible image captured in a high illumination environment and an image obtained by detecting an eyepoint of a user in the visible image. Referring to FIG. 6A, the image processor 120 of FIG. 1 may detect the eyepoint of the user by extracting a feature point of the visible image from a first database. The image processor 120 may detect a face of the user by extracting a feature point of the face from the visible image, detect an eye of the user based on the detected face, and determine a center of the eye to be the eyepoint of the user.

FIG. 6B illustrates an infrared image captured in a low illumination environment and an image obtained by detecting an eyepoint of a user in the infrared image. Referring to FIG. 6B, the image processor 120 may detect the eyepoint of the user by extracting a feature point of the infrared image from a second database. The image processor 120 may detect a face of the user by extracting a feature point of the face from the infrared image, detect an eye of the user based on the detected face, and determine a center of the eye to be the eyepoint of the user.

FIG. 6C illustrates an infrared image captured in a low illumination environment and an image obtained by detecting an eyepoint of a user in the infrared image. Referring to FIG. 6C, the image processor 120 may detect the eyepoint of the user by extracting a feature point of the infrared image from a second database. The image processor 120 may determine the eyepoint of the user based on various feature points of an eye extracted from the second database, without detecting a face of the user. For example, the image processor 120 may detect the eye of the user based on a feature point of an eye shape, and determine a center of the eye to be the eyepoint of the user.

Referring back to FIG. 1, the controller 130 may determine, based on an ambient illumination, an operating mode of the eye tracking apparatus to be a low illumination mode (first illumination mode) or a high illumination mode (second illumination mode). The controller 130 may compare the ambient illumination to a predetermined and/or selected threshold value, and determine the operating mode to be the high illumination mode in the high illumination environment and to be the low illumination mode in the low illumination environment.

The illumination sensor 150 may detect the ambient illumination. The illumination sensor 150 may be externally exposed from the image capturer 110 to detect an illumination. The illumination sensor 150 may transmit information on the ambient illumination to the controller 130.

The controller 130 may control an operation of any one of the optical source 111, the image corrector 115, and the image processor 120 based on the determined operating mode. The controller 130 may control the optical source 111 to emit infrared light to the user in the low illumination mode. Also, the controller 130 may control the image corrector 115 and the image processor 120 to correct the image and process the image based on the ambient illumination.

In addition, the optical source 111, the image corrector 115, and the image processor 120 may directly receive the information on the ambient illumination from the illumination sensor 150, and operate based on the ambient illumination.

According to at least some example embodiments described herein, the eye tracking apparatus may track an eyepoint of a user adaptively to a high illumination environment and a low illumination environment.

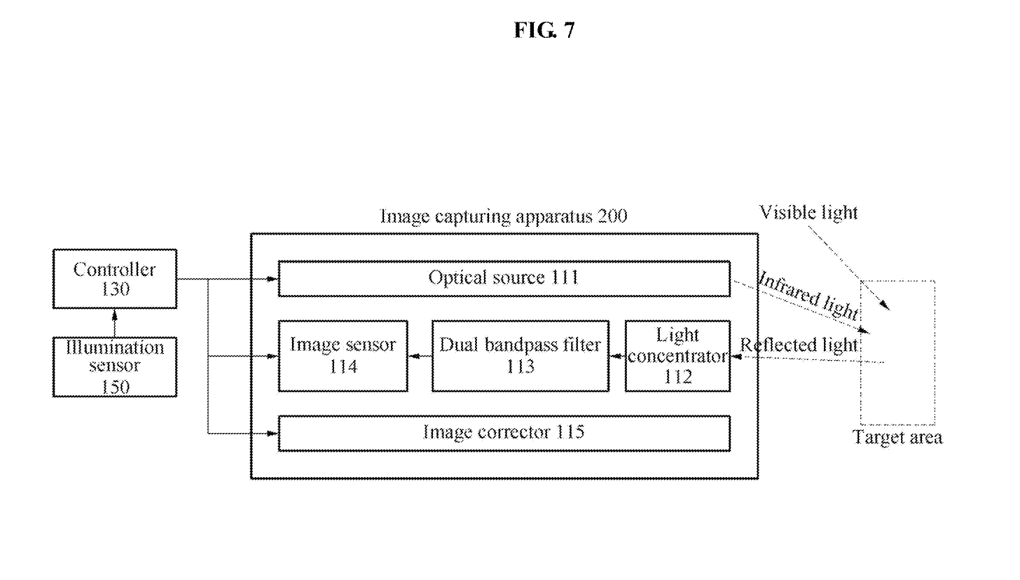

FIG. 7 is a diagram illustrating an example of an image capturing apparatus 200 according to at least one example embodiment.

Referring to FIG. 7, the image capturing apparatus 200 includes an optical source 111, a light concentrator 112, a dual bandpass filter 113, an image sensor 114, an image corrector 115, a controller 130, and an illumination sensor 150.

The controller 130 determines, based on an ambient illumination, an operating mode to be a high illumination mode or a low illumination mode. The controller 130 compares the ambient illumination to a predetermined and/or selected threshold value, and determines the operating mode to be the high illumination mode in a high illumination environment and to be the low illumination mode in a low illumination environment.

The controller 130 controls an operation of at least one of the optical source 111 and the image corrector 115 based on the determined operating mode. The controller 130 may control the optical source 111 to emit infrared light to a user in the low illumination mode. In addition, the controller 130 may control the image corrector 115 to correct an image based on the ambient illumination.

The optical source 111 emits infrared light to a target area in the low illumination mode. The target area may refer to an area to be captured. The optical source 111 may emit near-infrared light within a center of 850 nm and a bandwidth of 100 nm.

The light concentrator 112 concentrates reflected light from visible light or infrared light. The light concentrator 112 may include a lens or a pinhole to concentrate the reflected light.

The dual bandpass filter 113 allows visible light and infrared light of the reflected light concentrated by the light concentrator 112 to pass. The dual bandpass filter 113 may allow visible light within a wavelength of 350 nm to 650 nm and near-infrared light within a wavelength of 800 nm to 900 nm to pass. The dual bandpass filter 113 may be an optical filter.

The image sensor 114 receives light passing through the dual bandpass filter 113. The image sensor 114 generates an image based on the received light. The image sensor 114 may include a CCD or a CMOS.

The image corrector 115 corrects the image generated by the image sensor 114. The image corrector 115 may process a visible image captured in the high illumination environment and an infrared image captured in the low illumination environment using different processes. For example, the image corrector 115 may perform demosaicing on the visible image captured in the high illumination environment.

The illumination sensor 150 detects the ambient illumination. The illumination sensor 150 may be externally exposed from the image capturing apparatus 200 to detect an illumination. The illumination sensor 150 may transmit information on the ambient illumination to the controller 130.

The image capturing apparatus 200 may capture an image of the target area in the high illumination environment and the low illumination environment using the optical source 111, the light concentrator 112, the dual bandpass filter 113, the image sensor 114, the image corrector 115, the controller 130, and the illumination sensor 150.

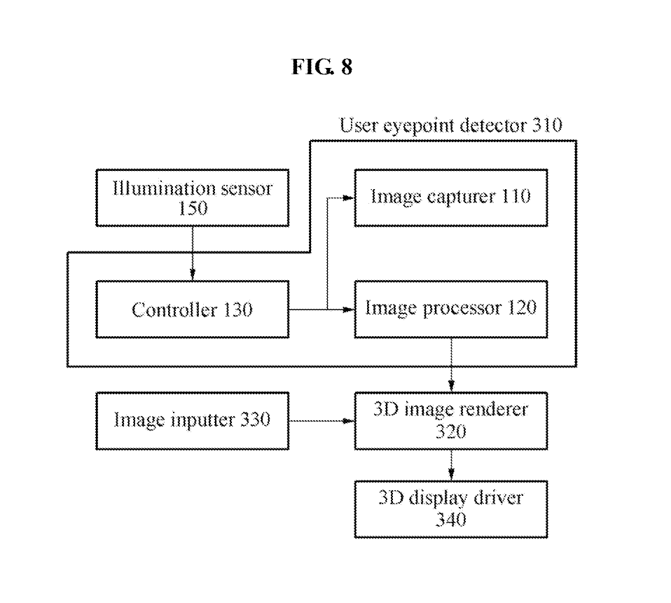

FIG. 8 is a diagram illustrating an example of a three-dimensional (3D) image display device according to at least one example embodiment.

Referring to FIG. 8, the 3D image display device includes a user eyepoint detector 310, a 3D image renderer 320, an image inputter 330, a 3D display driver 340, and an illumination sensor 150.

At least one of the 3D image renderer 320, image inputter 330 and 3D display driver 340 may be hardware, firmware, hardware executing software or any combination thereof. When the at least one of the 3D image renderer 320, image inputter 330 and 3D display driver 340 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the at least one of the 3D image renderer 320, image inputter 330 and 3D display driver 340. As stated above, CPUs, DSPs, ASICs and FPGAs may generally be referred to as processing devices.

In the event where the at least one of the 3D image renderer 320, image inputter 330 and 3D display driver 340 is a processor executing software, a processor is configured as a special purpose machine to execute the software, stored in a storage medium, to perform the functions of the at least one of the 3D image renderer 320, image inputter 330 and 3D display driver 340.

The user eyepoint detector 310 captures an image of a user in a low illumination mode or a high illumination mode as an operating mode based on an ambient illumination, and detects an eyepoint of the user in the captured image. The user eyepoint detector 310 may transmit coordinate values of the detected eyepoint of the user to the 3D image renderer 320.

The user eyepoint detector 310 may include an image capturer 110, an image processor 120, and a controller 130.

The image capturer 110 may include the optical source 111, the light concentrator 112, the dual bandpass filter 113, the image sensor 114, and the image corrector 115, as described with reference to FIG. 1. The descriptions of the optical source 111, the light concentrator 112, the dual bandpass filter 113, the image sensor 114, and the image corrector 115, which are provided with reference to FIG. 1, may be identically applicable hereto and thus, repeated descriptions will be omitted for brevity.

The image processor 120 detects the eyepoint of the user in an image output from the image corrector 115. The image processor 120 may use a first database including visible images and a second database including infrared images to detect the eyepoint of the user in the captured image.

The controller 130 determines the operating mode to be the low illumination mode or the high illumination mode based on the ambient illumination. The controller 130 compares the ambient illumination to a predetermined and/or selected threshold value, and determines the operating mode to be the high illumination mode in a high illumination environment and to be the low illumination mode in a low illumination environment.

The controller 130 controls an operation of at least one of the image capturer 110 and the image processor 120 based on the determined operating mode. The controller 130 may control the optical source 111 to emit infrared light to the user in the low illumination mode. In addition, the controller 130 may control the image processor 120 to process the image based on the ambient illumination.

The illumination sensor 150 detects the ambient illumination. The illumination sensor 150 may be externally exposed from the image capturer 110 to detect an illumination. The illumination sensor 150 may transmit information on the ambient illumination to the controller 130.

The 3D image renderer 320 renders a 3D image corresponding to the detected eyepoint of the user. The 3D image renderer 320 may render a stereo image in the form of a 3D image for a glassless 3D display. The 3D image renderer 320 may render a 3D image corresponding to the coordinate values of the eyepoint of the user received from the user eyepoint detector 310.

The image inputter 330 inputs an image to the 3D image renderer 320. The 3D image renderer 320 may render the image input by the image inputter 330 in the form of a 3D image corresponding to the detected eyepoint of the user.

The image input by the image inputter 330 to the 3D image renderer 320 may be the stereo image. The image inputter 330 may receive the input image through communication with an internal storage device, an external storage device, or an external device of the 3D display device.

The 3D display driver 340 outputs the 3D image received from the 3D image renderer 320. The 3D display driver 340 may include a display to output the 3D image. For example, the 3D display driver 340 may include at least one of a liquid crystal display (LCD), a light-emitting diode (LED) display, an organic light-emitting diode (OLED) display, and a plasma display.

The 3D image display device may display the 3D image corresponding to the eyepoint of the user in the high illumination environment and the low illumination environment using the user eyepoint detector 310, the 3D image renderer 320, the image inputter 330, the 3D display driver 340, and the controller 130.

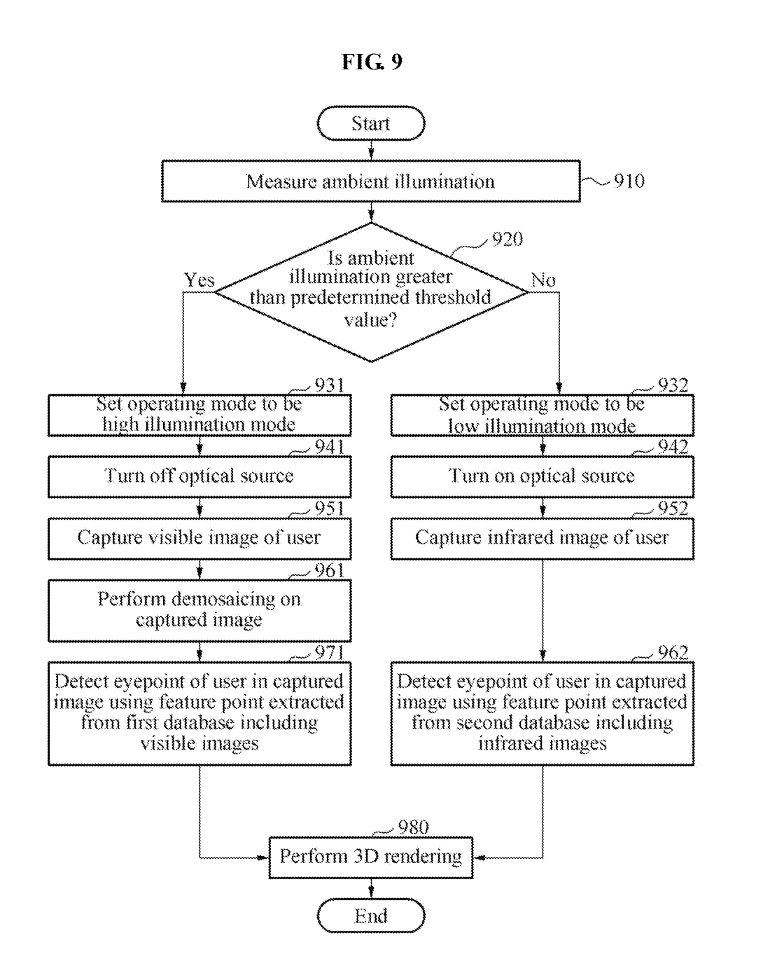

FIG. 9 is a flowchart illustrating an example of an eye tracking method according to at least one example embodiment. The eye tracking method may be performed by an eye tracking apparatus.

Referring to FIG. 9, in operation 910, the eye tracking apparatus measures an ambient illumination. The eye tracking apparatus may measure the ambient illumination around the eye tracking apparatus using an externally exposed illumination sensor.

In operation 920, the eye tracking apparatus compares the ambient illumination to a predetermined and/or selected threshold value. The eye tracking apparatus may determine an operating mode to be a high illumination mode in a high illumination environment and to be a low illumination mode in a low illumination environment by comparing the ambient illumination to the predetermined and/or selected threshold value.

Hereinafter, operations 931, 941, 951, 961, and 971 will be described based on a case in which the ambient illumination is determined to be greater than or equal to the predetermined and/or selected threshold value in the high illumination mode.

In operation 931, the eye tracking apparatus sets the operating mode to be the high illumination mode. The eye tracking apparatus may perform processes of controlling an operation of an optical source, preprocessing a captured image, and detecting an eyepoint of a user in response to the high illumination mode.

In operation 941, the eye tracking apparatus turns off the optical source. Thus, the eye tracking apparatus may obtain a visible image that is not affected by infrared light.

In operation 951, the eye tracking apparatus captures a visible image of the user. The eye tracking apparatus may capture the visible image of the user in response to the high illumination mode as the operating mode.

In operation 961, the eye tracking apparatus performs demosaicing on the captured image. The visible image may include a grid Bayer pattern and thus, the eye tracking apparatus may perform the demosaicing on the captured image to detect the eyepoint of the user.

In operation 971, the eye tracking apparatus detects the eyepoint of the user in the captured image using a feature point extracted from a first database including visible images.

The first database may be trained in a feature point of a visible image. For example, the first database may include various feature points of a facial contour trained from the visible images and data on a position of an eye based on the feature points of the facial contour.

The eye tracking apparatus may detect a face of the user by extracting a feature point of the face of the user from the visible image, detect the eye of the user based on the detected face, and determine a center of the detected eye to be the eyepoint of the user.

Hereinafter, operations 932, 942, 952 and 962 will be described based on a case in the low illumination mode determined when the ambient illumination is less than the predetermined and/or selected threshold value.

In operation 932, the eye tracking apparatus sets the operating mode to be the low illumination mode. The eye tracking apparatus may perform processes of controlling an operation of the optical source, preprocessing a captured image, and detecting an eyepoint of the user in response to the low illumination mode.

In operation 942, the eye tracking apparatus turns on the optical source. Thus, the eye tracking apparatus may obtain an infrared image based on infrared light emitted by the optical source.

In operation 952, the eye tracking apparatus captures an infrared image of the user. The eye tracking apparatus may capture the infrared image of the user in response to the low illumination mode functioning as the operating mode.

In operation 962, the eye tracking apparatus detects the eyepoint of the user in the captured image using a feature point extracted from a second database including infrared images.

The second database may be trained in a feature point of an infrared image. For example, the second database may include various feature points of a facial contour trained from the infrared images and data on a position of an eye based on the feature points of the facial contour. The eye tracking apparatus may detect a face of the user in the infrared image by extracting the feature points of the face of the user, detect the eye of the user based on the detected face, and determine a center of the eye to be the eyepoint of the user.

In addition, the second database may include data on various feature points of the eye trained from the infrared images. The eye tracking apparatus may detect the eye of the user based on a feature point of an eye shape, and determine the center of the eye to be the eyepoint of the user.

In operation 980, the eye tracking apparatus performs 3D rendering. The eye tracking apparatus may render a 3D image corresponding to coordinate values of the detected eyepoint of the user. The eye tracking apparatus may receive an input image through communication with an internal storage device, an external storage device, or an external device, and render the input image into the 3D image.

Through operations 910 through 980, the eye tracking apparatus may detect the eyepoint of the user in the high illumination environment and the low illumination environment, and output the 3D image corresponding to the detected eyepoint of the user.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media (storage medium) including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An eye tracking apparatus, comprising:
an image capturer configured to capture an image of a user;
an image processor configured to detect an eyepoint of the user in the captured image; and
a controller configured to determine an operating mode based on an ambient illumination and control an operation of at least one of the image capturer and the image processor based on the determined operating mode, the determined operating mode being one of a first illumination mode and a second illumination mode, the second illumination mode associated with a higher illumination environment than the first illumination mode.

2. The apparatus of claim 1, wherein the controller is configured to determine the operating mode by comparing the ambient illumination to a threshold value.

3. The apparatus of claim 1, further comprising:
an optical source configured to emit infrared light to the user in the first illumination mode.

4. The apparatus of claim 3, wherein the optical source is configured to emit near-infrared light within a center of 850 nanometers (nm) and a bandwidth of 100 nm to the user in the first illumination mode.

5. The apparatus of claim 1, wherein the image capturer comprises:
a dual bandpass filter configured to allow visible light and infrared light to pass.

6. The apparatus of claim 5, wherein the dual bandpass filter is configured to allow visible light within a wavelength of 350 nm to 650 nm and near-infrared light within a wavelength of 800 nm to 900 nm to pass.

7. The apparatus of claim 1, wherein the image processor is configured to detect the eyepoint of the user in the captured image using a feature point from a first database, the first database including visible images in the second illumination mode, and
the image processor is configured to detect the eyepoint of the user in the captured image using a feature point from a second database, the second database including infrared images in the first illumination mode.

8. The apparatus of claim 7, wherein the image capturer further comprises:
an image corrector configured to correct the captured image, and
the image corrector is configured to perform demosaicing on the captured image in the second illumination mode.

9. An image capturing apparatus, comprising:
a controller configured to determine an operating mode based on an ambient illumination, the determined operating mode being one of a first illumination mode and a second illumination mode, the second illumination mode associated with a higher illumination environment than the first illumination mode;
an optical source configured to emit infrared light to a target area in the first illumination mode;
a dual bandpass filter configured to allow infrared light and visible light to pass;
an image sensor configured to generate an image by receiving light filtered by the dual bandpass filter; and
an image corrector configured to correct the generated image.

10. The apparatus of claim 9, wherein the optical source is configured to emit near-infrared light within a center of 850 nm and a bandwidth of 100 nm, and
the dual bandpass filter is configured to allow visible light within a wavelength of 350 nm to 650 nm and infrared light within a wavelength of 800 nm to 900 nm to pass.

11. The apparatus of claim 9, wherein the image corrector is configured to perform demosaicing on the generated image in the second illumination mode.

12. An eye tracking method, comprising:
determining an operating mode based on an ambient illumination, the determined operating mode being one of a first illumination mode and a second illumination mode, the second illumination mode associated with a higher illumination environment than the first illumination mode;
capturing an image of a user based on the determined operating mode; and
detecting an eyepoint of the user in the captured image.

13. The method of claim 12, further comprising:
emitting infrared light to the user in the first illumination mode.

14. The method of claim 12, wherein the capturing is based on reflected light passing through a dual bandpass filter configured to allow visible light and infrared light to pass.

15. The method of claim 12, wherein the capturing includes,
capturing a visible image of the user in the second illumination mode, and
capturing an infrared image of the user in the first illumination mode.

16. The method of claim 12, wherein the detecting uses a feature point from a first database including visible images in the second illumination mode.

17. The method of claim 12, wherein the detecting uses a feature point from a second database including infrared images in the first illumination mode.

18. The method of claim 12, further comprising:
demosaicing the captured image in the second illumination mode.
